(19) United States
(12) Patent Application Publication
(10) Pub. No.: US 2026/0238373 A1
(43) Pub. Date: Aug. 13, 2026

(54) Wavelength Management in Multi-Rail Optical Networks

(71) Applicant: Ciena Corporation, Hanover, MD (US)

(72) Inventor: Choudhury A. Al Sayeed, Stittsville (CA)

(73) Assignee: Ciena Corporation, Hanover, MD (US)

(21) Appl. No.: 19/049,460

(22) Filed: Feb. 10, 2025

(51) Int. Cl. H04J 14/02; H04Q 11/00

(52) U.S. Cl. CPC H04J 14/0287; H04J 14/021; H04Q 11/0062; H04Q 2011/0086

(57) ABSTRACT

Systems and methods of managing optical wavelengths in a multi-rail optical network are provided, and the network includes at least two parallel rails each configured to carry optical signals between a first node and a second node. In an embodiment, a method includes assigning a first subset of spectral slots of a plurality of spectral slots of available optical spectrum to a first rail and a second subset of the spectral slots to a second rail in an interleaved manner such that at least some of the slots allocated to the first rail alternate with slots allocated to the second rail; transmitting traffic within one or more protected slots among the plurality of spectral slots while transmitting lower-priority traffic or having no traffic in remaining slots; and in response to detecting a failure in the first rail, locally switching the traffic from the first rail to the second rail by reassigning the protected slots onto the operational rail.

### FIELD OF THE DISCLOSURE

The present disclosure relates generally to optical networking. More particularly, the present disclosure relates to systems and methods for wavelength management in multi-rail optical networks.

### BACKGROUND OF THE DISCLOSURE

A multi-rail optical network includes multiple parallel optical paths, referred to as “rails,” that connect the same nodes or spans within the network. Each rail carries its own subset of traffic, thereby dividing the overall capacity among several distinct conduits rather than relying on a single pipe. As demand from large-scale content and cloud providers continues to escalate, multi-rail architectures are increasingly deployed to address both bandwidth requirements and the inherent limitations of single-pipe designs. These architectures often manifest as parallel fiber pairs running between or within data centers, typically featuring add/drop capabilities and support for express traffic. The parallel fibers may or may not reside in the same physical conduit, and they can scale from two pairs to sixteen or more. Because rail counts may vary along a given optical path and optical redundancy is essential for handling potential rail failures, effective wavelength and spectrum management in a multi-rail setup has become a principal concern for network operations.

### BRIEF SUMMARY OF THE DISCLOSURE

The present disclosure relates to systems and methods for wavelength management in multi-rail optical networks. It describes an approach to optical protection that interleaves high-priority traffic across multiple rails and uses local ROADMs to switch only the “active” protected wavelengths around specific failures. This reduces complexity, enables partial protection for selected wavelengths, and can be reconfigured in software—offering clear operational benefits for large, multi-rail deployments. Multi-rail architectures, ranging from quad (4×) to 16×, are poised to enter the market as early as 2026, with various vendors already developing the requisite hardware to meet anticipated demand from major cloud and content providers. While most service providers currently rely on their own planning tools for spectrum management, the presence of multiple parallel rails significantly complicates wavelength assignments, particularly when handling multiple rail failures and ensuring adequate optical redundancy.

Accordingly, the present disclosure provides multiple techniques for mitigating these challenges:
(1) Interleaving Bandwidth Allocation: Proposing interleaving bandwidth allocation across parallel rails within an optical multiplex section (OMS).
(2) Rail Clustering: Clustering two or more rails for overlapping bandwidth assignments, while maintaining interleaving assignments among clusters within the OMS.
(3) Sub-Spectrum Management: Allocating interleaving spectral assignments in a sub-part of the spectrum using one formation (spacing and slot width) and employing a different formation in another sub-part of the spectrum.
(4) Equivalent Spectral Assignments Across OMS Sections: Maintaining equivalent interleaving spectral assignments between different clusters and rails from one OMS to the next, in order to simplify express channel propagation and network operations for rail-failure handling.

These techniques will be especially valuable for designing wavelength management strategies in complex multi-rail scenarios, where they can be provided or bundled within existing planning solutions.

In an embodiment, a method of managing optical wavelengths in a multi-rail optical network is provided, and the network includes at least two parallel rails each configured to carry optical signals between a first node and a second node. The method includes assigning to a first rail and a second rail, a first subset and a second subset respectively of a plurality of spectral slots of available optical spectrum such that one or more of the slots in the first subset are non-overlapping with slots in the second subset; transmitting protected traffic within non-overlapping slots; and, in response to detecting a failure in the first rail, locally switching the protected traffic from the first rail to the second rail.

In another embodiment, a reconfigurable optical add-drop multiplexer (ROADM) includes an optical switching subsystem that includes one or more wavelength-selective switches (WSSs); and a controller operably coupled to the optical switching subsystem, wherein the controller is configured to assign to a first rail and a second rail, a first subset and a second subset respectively of a plurality of spectral slots of available optical spectrum such that one or more of the slots in the first subset are non-overlapping with slots in the second subset, and wherein protected traffic is transmitted within non-overlapping slots, and, in response to detecting a failure in the first rail, cause a local switch of the protected traffic from the first rail to the second rail.

### BRIEF DESCRIPTION OF THE DRAWINGS

The present disclosure is detailed through various drawings, where like components or steps are indicated by identical reference numbers for clarity and consistency.

FIG. 1 illustrates an example multi-rail optical network that includes four reconfigurable optical add-drop multiplexers (ROADMs), interconnected by three OMSs.

FIGS. 2A-2B illustrate an OMS that connects two ROADMs via two parallel rails (labeled rail #1 and rail #2), thereby providing a simple example of interleaving wavelength assignment.

FIG. 3 illustrates an OMS operating in a quad-rail configuration, showcasing a more advanced application of interleaved spectrum allocation.

FIG. 4 illustrates the OMS of FIG. 3 in a scenario where clustering is employed to manage wavelength assignments across multiple rails.

FIG. 5 illustrates the OMS of FIGS. 3 and 4 illustrating phase shifted spectrum allocation with uneven-spacing and variable-width slots for spectrum allocation

FIG. 6 illustrates an OMS configured with sixteen parallel rails in a quad clustering arrangement (i.e., four clusters, each with four rails).

FIG. 7 illustrates an example of the multi-rail optical network of FIG. 1, demonstrating how inter-OMS bandwidth management can be achieved even when different OMSs have varying numbers of rails.

FIG. 8 illustrates another view of the multi-rail optical network, illustrating both inter-OMS bandwidth management and the mechanisms for handling rail failures.

FIG. 9 illustrates a multi-rail optical network including four OMSs, demonstrating the benefits of performing local switching in the event of a rail (or cluster) failure.

FIG. 10 illustrates an OMS 80 configured to enable sub-spectrum protection, meaning only a defined subset of the overall spectral band is reserved for high-priority traffic with interleaving-based protection.

FIG. 11 illustrates a flowchart of a process of managing optical wavelengths in a multi-rail optical network.

FIG. 12 illustrates a flowchart of another process of managing optical wavelengths in a multi-rail optical network.

### DETAILED DESCRIPTION OF THE DISCLOSURE

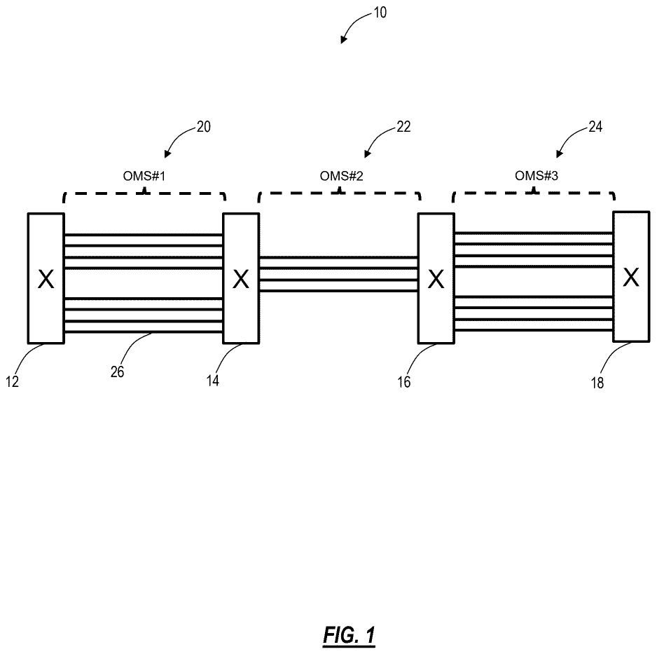

FIG. 1 illustrates an example multi-rail optical network 10 that includes four ROADMs 12, 14, 16, and 18, interconnected by three OMSs 20, 22, and 24. In this context, the multi-rail optical network 10 is one in which multiple parallel optical paths or rails 26 are employed between nodes (the ROADMs), thereby increasing overall capacity and providing added resiliency against failures. Each ROADM 12, 14, 16, 18 can locally add or drop selected channels and dynamically redirect (i.e., reconfigure) the optical signals passing through it, effectively controlling which rails 26 carry which wavelengths. Each rail 26 within each OMS 20, 22, 24 represents the physical medium (often two physical fibers for bi-directional traffic) linking one ROADM to the next. Although FIG. 1 shows each rail 26 as a single line, real-world deployments can include additional components such as intermediate amplifiers for boosting signal strength, dispersion compensation modules, or other optical devices (not shown). Further, the diagram is logical in nature, depicting connectivity rather than detailed hardware layouts.

Notably, the number of rails 26 in each OMS 20, 22, 24 may differ based on capacity, redundancy, or service-level requirements. For example, the OMSs 20 and 24 are shown with eight rails 26 each, while the OMS 22 includes only four, illustrating a scenario where the mid-span (the OMS 22) offers fewer parallel paths than the outer sections. Such an arrangement can arise from practical considerations, for instance, certain routes may support more fibers, or only a subset of rails might be deployed in a given segment due to cost or infrastructure constraints. Because each rail 26 acts as a logically distinct conduit for traffic, having differing rail counts across OMSs 20, 22, 24 introduces complexity in wavelength assignment, path planning, and protection strategies. In particular, the ROADM nodes must manage how traffic merges and splits when transitioning between an OMS with fewer rails (the OMS 22) and one with more rails (the OMS 20, 24), ensuring that network performance, redundancy, and throughput targets are met.

A ROADM 12, 14, 16, 18 is a network element in the optical network 10 that enables dynamic routing of individual wavelength channels without requiring manual fiber patching. In essence, a ROADM takes in multiple wavelength channels on an incoming fiber, allows certain channels to be “dropped” (i.e., diverted for local use) and others to be “added” (i.e., originating locally and inserted onto the fiber), and then passes the remaining channels straight through to the next link. The “reconfigurable” aspect comes from the ability to remotely program which wavelength channels are added, dropped, or expressed, typically through software control. This flexibility is achieved via optical switching modules, commonly based on wavelength-selective switches (WSSs), which operate in the optical domain and can be reprogrammed in near real time to adapt to shifting traffic demands or to reroute around network faults. By offering such versatile control, ROADMs greatly reduce operational costs, speed up service deployment, and facilitate more efficient use of the optical network's capacity.

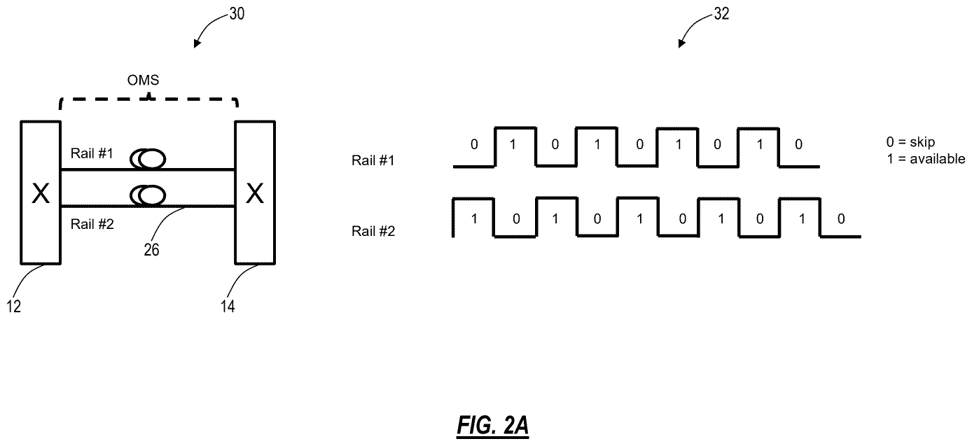

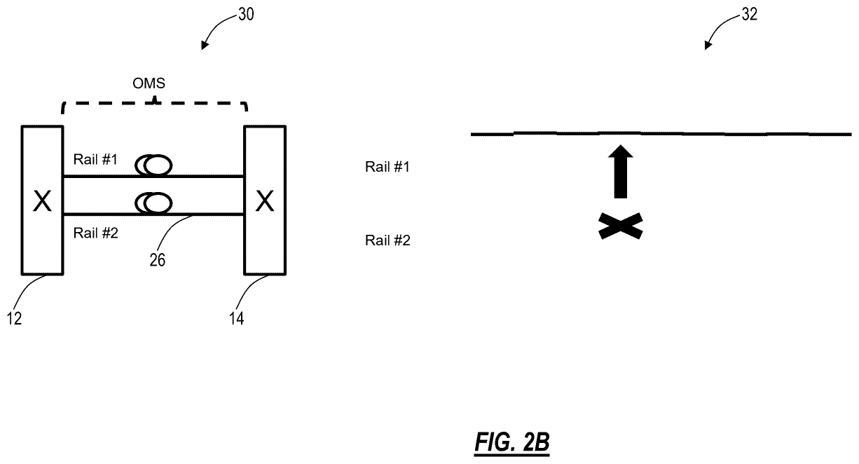

FIGS. 2A-2B illustrate an OMS 30 that connects two ROADMs 12, 14 via two parallel rails 26 (labeled rail #1 and rail #2), thereby providing a simple example of interleaving wavelength assignment. In particular, FIG. 2A illustrates the two parallel rails 26 both operational and FIG. 2B illustrates one rail 26 with a failure and the other rail operational. In this dual-rail configuration, the entire available spectrum (e.g., the C-band, totaling around 4875 GHZ) is logically partitioned into a series of slots based on the desired channel spacing and bandwidth, such as, e.g., 65 slots at 75 GHz apiece. These slots are then alternately allocated to each rail (odd-numbered slots to rail #1, even-numbered slots to rail #2), creating an interleaving pattern that facilitates straightforward redundancy. While a uniform, evenly spaced slot width simplifies assignments, more advanced deployments may use variable slot widths and uneven spacing to accommodate different signal types and path constraints; in all cases, however, maintaining an interleaved allocation between rails remains a key priority. This approach provides 100% redundancy against rail-specific failures, such as fiber cuts, amplifier (erbium doped fiber amplifier (EDFA) or Raman) malfunctions, or spectrum-switch outages, by allowing a single rail to temporarily carry all traffic if the other rail goes down. In normal operation, each rail carries approximately 1/N of the total load (where N is the number of parallel rails in the OMS), ensuring optimal sharing of capacity while retaining full protection in the event of a rail failure.

In the event of a failure on either rail #1 or rail #2 within the OMS 30, the remaining operational rail can temporarily assume the entire traffic load from the failed rail to maintain service continuity. This is shown in FIG. 2B where the rail #2 fails and all of the traffic is switched to the rail #1. This process is typically orchestrated by the ROADMs 20, 22, which detect the loss of optical signal (for instance, through alarm conditions or power-level monitoring) and then dynamically reroute the affected wavelength channels onto the surviving rail. Because the two rails share the total spectrum through an interleaving assignment, they can be configured via software-controlled switching elements (often WSSs) to repurpose the spectral slots of the working rail for both normal and restored traffic. Once the failed rail is repaired or otherwise becomes operational again, the ROADMs can switch the traffic back, returning the network to its balanced, multi-rail state. This design ensures that even with dual rails, each rail can carry 100% of the total traffic in a protection scenario, minimizing downtime and manual intervention.

A diagram 32 provides a logical representation of how the optical spectrum may be partitioned in an interleaved manner between two rails. In the diagram 32 and subsequent diagrams of optical spectrum per rail, along the x-axis, frequency or wavelength is shown, while the y-axis indicates whether a particular range is “occupied” (depicted by a high line or peak) or “unoccupied” (depicted by a low line or baseline). When a high line appears in a row, that rail has allocated channels in that frequency band, whereas a low line indicates free (unassigned) spectrum. In particular, in FIG. 2A, the diagram 32 shows the rails 26 having disjoint usage of the optical spectrum for the interleaved manner, whereas in FIG. 2B, the diagram shows the entire optical spectrum for the rail #1 used as the rail #2 has a failure and its traffic is switched to the rail #1.

In this example of the diagram 32, the frequency (or wavelength) axis is divided into discrete slots, where alternating slots are allocated to rail #1 and rail #2. For instance, odd-numbered slots may go to rail #1 while even-numbered slots go to rail #2. Each slot can be uniformly sized (e.g., 75 GHz) or have variable widths to accommodate different signal formats and bandwidth requirements. This interleaving ensures that each rail receives its own, non-overlapping portion of the total available spectrum, allowing traffic to be balanced between the two rails in normal operation. In addition, because each slot is dedicated to a single rail, any loss of signal on one rail can be detected and handled by reassigning those wavelengths to the surviving rail, which is particularly useful in scenarios where redundancy is desired.

Of note, while specific examples in the present disclosure reference particular slot sizes or slot counts for illustrative purposes (e.g., 75 GHz-wide slots or a total of 65 slots), those skilled in the art will recognize that a wide range of parameter choices and configurations is possible. The total spectrum available, the desired channel spacing, and the underlying modulation formats can all influence how the slots are defined, sized, and allocated. For instance, some systems may use a standardized 50 GHz grid, whereas others could employ finer granularity at 37.5 GHz or adopt flex-grid solutions with variable slot widths. Similarly, the overall number of slots can vary depending on the C-band (or other bands) available, the presence of super channels, and the specific throughput or protection objectives of the network. Accordingly, the examples provided herein are not intended to limit the scope of the concepts presented, and numerous other values and approaches for slotting, spacing, and spectral allocation remain fully within the spirit of these teachings.

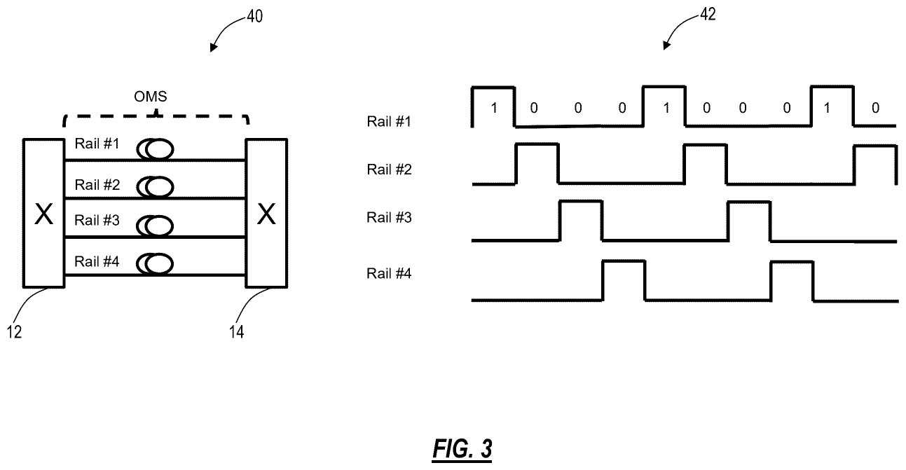

FIG. 3 illustrates an OMS 40 operating in a quad-rail configuration, showcasing a more advanced application of interleaved spectrum allocation. In this setup, four rails are provisioned with non-overlapping spectral slots assigned to each rail in an interleaved pattern, thereby providing 100% protection in the event of rail failures. Specifically, the interleaved method can tolerate up to three rail failures out of four (i.e., 3:4), because all traffic can be switched onto the single remaining rail. Generalizing this concept, an N-rail network can be designed to withstand up to (N−1) simultaneous rail failures under the same principle, thereby redistributing the failed rail's traffic to any surviving rails.

Two additional considerations arise when N becomes large. First, partitioning a fixed spectrum into too many rails may result in spectral slots that are too narrow to accommodate wide-band signals, leading to inefficient utilization. For instance, splitting a 4875 GHz C-band equally among 16 rails yields slots of only about 300 GHz each, which is a width that may be insufficient for higher-bandwidth channels. Second, not all networks require tolerance for (N−1) simultaneous failures, as the probability of multiple rails failing at the same time decreases with each additional rail. In such cases, clustering techniques can be employed to group subsets of rails together for shared protection, striking a balance between maximizing capacity efficiency and ensuring the desired level of survivability.

A diagram 42 provides a logical representation of how the available optical spectrum can be subdivided into four distinct, interleaved sets of frequency slots, one set per rail, in a quad-rail configuration. Each horizontal row corresponds to a particular rail, and the row includes discrete spectral slots allocated exclusively to that rail. By distributing slots in a round-robin or staggered fashion (i.e., first slot to rail #1, second slot to rail #2, third slot to rail #3, fourth slot to rail #4, then repeating), the diagram illustrates how traffic can be balanced and protected across multiple parallel paths. This interleaving ensures that each rail has its own non-overlapping portion of the total spectrum, thereby simplifying redundancy strategies: if one rail becomes unavailable, the ROADMs can redirect its channels into unused capacity on any remaining rails. Though the diagram depicts uniform slot sizes, more sophisticated approaches might employ variable slot widths tailored to different signal formats or bandwidth requirements.

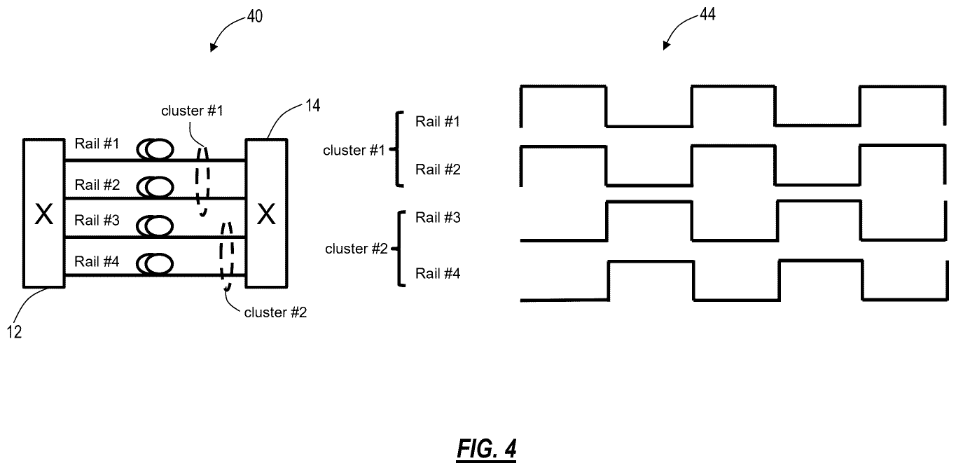

FIG. 4 illustrates the OMS 40 in a scenario where clustering is employed to manage wavelength assignments across multiple rails. Clustering refers to grouping two or more rails so that they share overlapping or even identical-bandwidth allocations, effectively combining the spectrum resources of each rail within a cluster. For instance, in a four-rail configuration, pairs of rails can be clustered to mimic a dual-rail allocation, enabling those two rails to carry the same or partly overlapping set of wavelength channels. If any rail within a cluster fails, its traffic can be restored by moving onto the surviving rails of another cluster, ensuring continuity of service.

The size and number of these clusters are typically chosen to meet specific fault-tolerance targets. For example, in a four-rail network, clustering into two pairs (M=2) ensures that if up to two rails (N/M=4/2=2) fail simultaneously, the remaining rails can still handle 100% of the traffic. Extending this logic to a sixteen-rail setup grouped into four clusters (M=4) would allow any four (N/M=16/4=4) of the rails to fail without impacting overall capacity, since the remaining twelve rails can accommodate the traffic load. Hence, clustering offers a flexible strategy for tailoring bandwidth protection to match network requirements, balancing the tradeoffs between full resilience and efficient spectrum use.

A diagram 44 illustrates how four parallel rails can be grouped into clusters for wavelength assignment, showing that rails #1 and #2 share overlapping (or identical) spectrum allocations while rails #3 and #4 form a separate cluster with their own overlapping allocations. The diagram 44 indicates that within a cluster (e.g., rails #1 and #2), the slots may be completely duplicated, partially overlapped, or otherwise arranged to provide redundancy in the event one rail fails. Meanwhile, the other cluster (rails #3 and #4) receives its own set of overlapping slots. By visually grouping the rails, the diagram 44 conveys how clustering enables two or more rails to share common spectrum assignments, allowing traffic on a failed rail in one cluster to be rerouted to surviving rails in another cluster, thereby achieving specified fault-tolerance objectives without forcing all rails to carry fully distinct allocations.

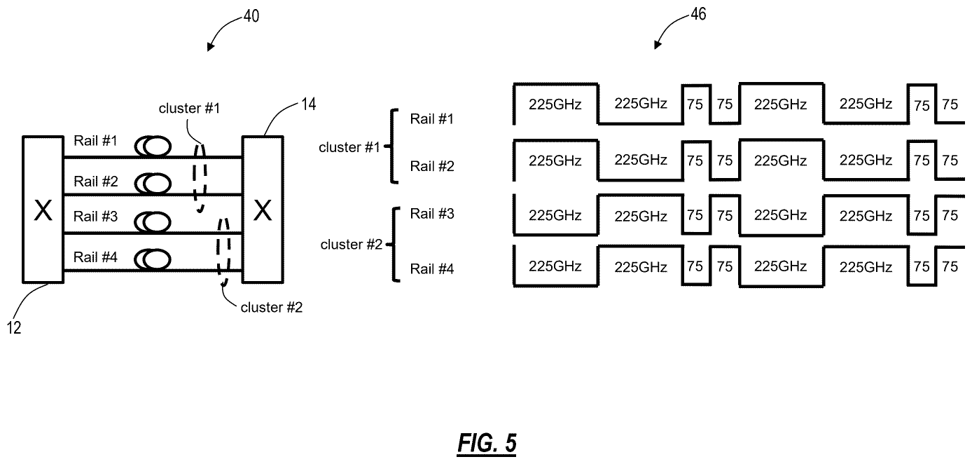

FIG. 5 illustrates the OMS 40 illustrating phase shifted spectrum allocation with uneven-spacing and variable-width slots for spectrum allocation. For example, this is an example of 180° phase shifted spectrum allocation. A diagram 46 provides a graphical representation of optical spectrum occupancy across multiple rails, with each horizontal row corresponding to one rail's usage of the available wavelengths. In essence, the diagram 46 illustrates how different rails might share, overlap, or remain vacant in certain parts of the spectrum, depending on the specific interleaving or clustering strategy.

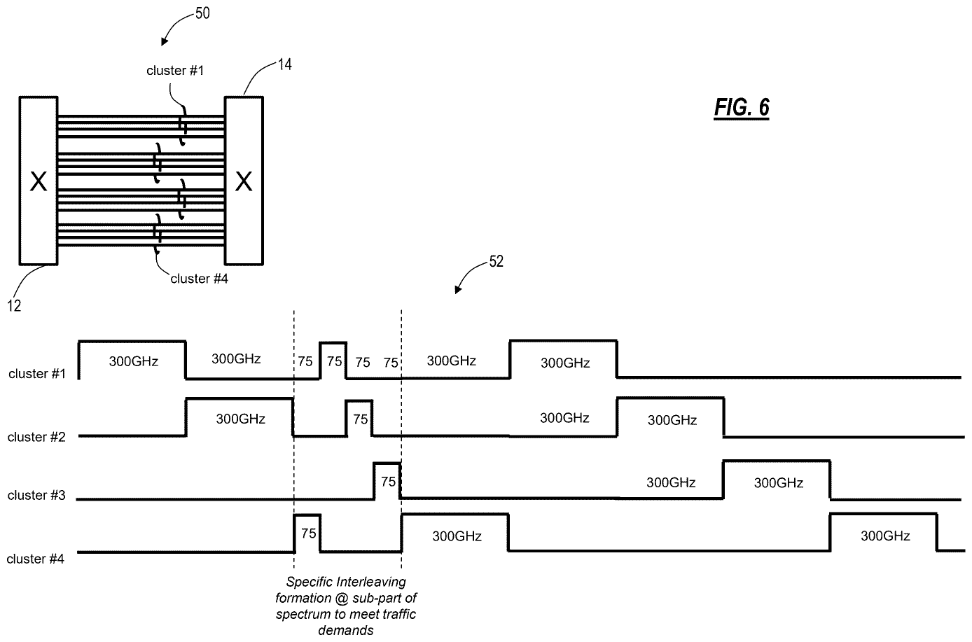

FIG. 6 illustrates an OMS 50 configured with sixteen parallel rails in a quad clustering arrangement (i.e., four clusters, each with four rails). This example demonstrates how an operator can apply one formation of interleaving, specifying particular slot widths and spacing, to a sub-band of the available spectrum while applying a different interleaving scheme to another sub-band. In other words, the total spectrum can be logically divided so that each region implements its own rules for spectral slot assignment, slot width, and rail mapping, allowing greater flexibility. A diagram 52 complements this view by depicting how these four clusters, each comprising multiple rails, might share overlapping or interleaved portions of the spectrum in one sub-band while adopting a different interleaving pattern elsewhere. By combining clustering (for fault tolerance) with multi-formation interleaving (for spectral efficiency), the arrangement shown in FIG. 6 and the diagram 52 illustrates a powerful strategy for simultaneously optimizing capacity, resiliency, and operational flexibility in large-scale optical networks.

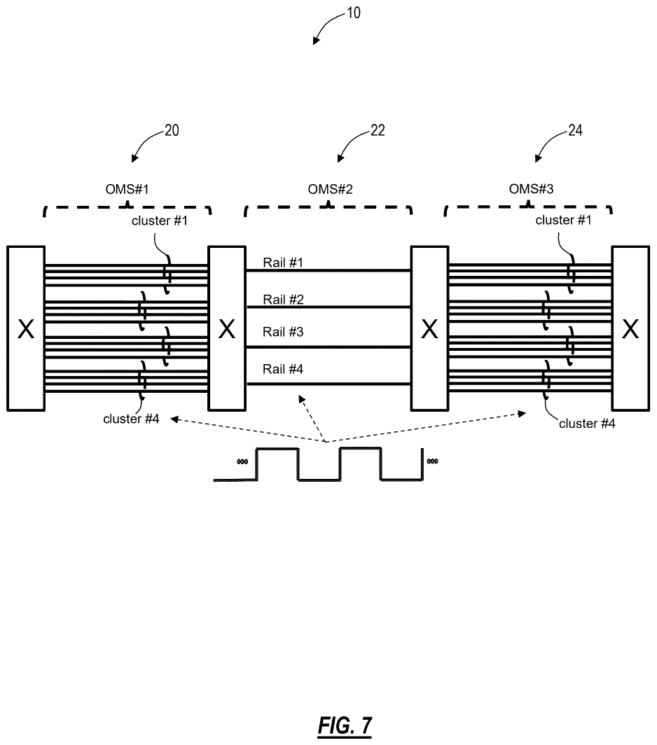

FIG. 7 illustrates an example of the multi-rail optical network 10, demonstrating how inter-OMS bandwidth management can be achieved even when different OMSs 20, 22, 24 have varying numbers of rails. The clustering concept remains effective for traffic channels that span multiple OMSs 20, 22, 24, because the assigned rails in one OMS may not match those in an adjacent OMS. By maintaining consistent interleaved bandwidth allocations across clusters, optical channels can be seamlessly “expressed” from one OMS to the next without requiring additional wavelength conversions or remapping. It is further shown that such consistency can extend beyond simple cluster-to-cluster assignments, ensuring that the bandwidth allocations in a cluster of one OMS align properly with the rails of another OMS. This unified approach simplifies network operations and preserves end-to-end signal integrity, allowing traffic to flow smoothly across the entire multi-rail network.

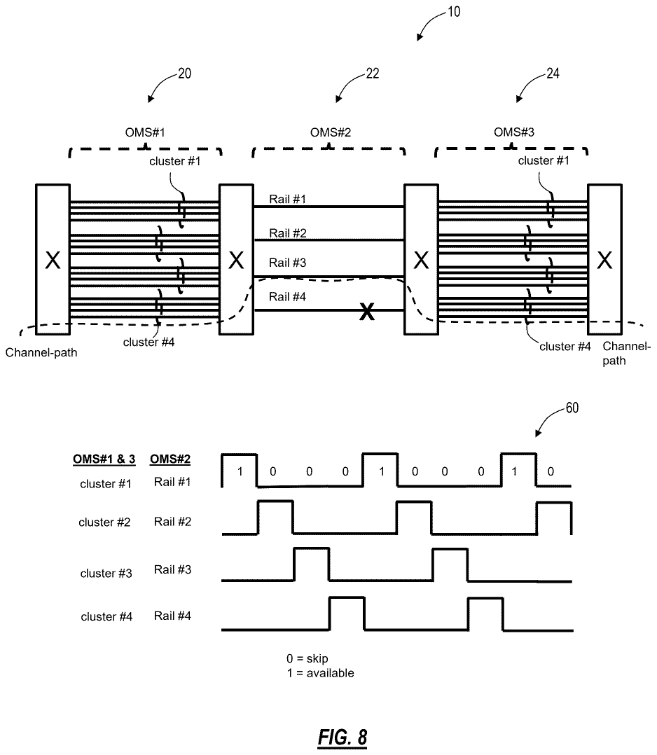

FIG. 8 illustrates another view of the multi-rail optical network 10, illustrating both inter-OMS bandwidth management and the mechanisms for handling rail failures. Here, each OMS is shown with multiple parallel rails, organized into clusters to optimize capacity and resiliency. When rail #4 in OMS 22 experiences a fault, all traffic associated with cluster #4 can be rerouted onto any other available rails within the OMS 22, effectively bypassing the failed rail. This is achieved through the ROADMs and wavelength-selective switches that dynamically reassign spectrum allocation in real time. By keeping the interleaved and clustered bandwidth assignments consistent across neighboring sections of the network, traffic that was originally mapped to cluster #4 remains “expressible” onto surviving rails, minimizing disruption and preserving throughput. A diagram 60 highlights how logical spectrum organization (interleaving and clustering) works in tandem with rapid fault detection and switching capabilities to ensure robust, flexible network operations.

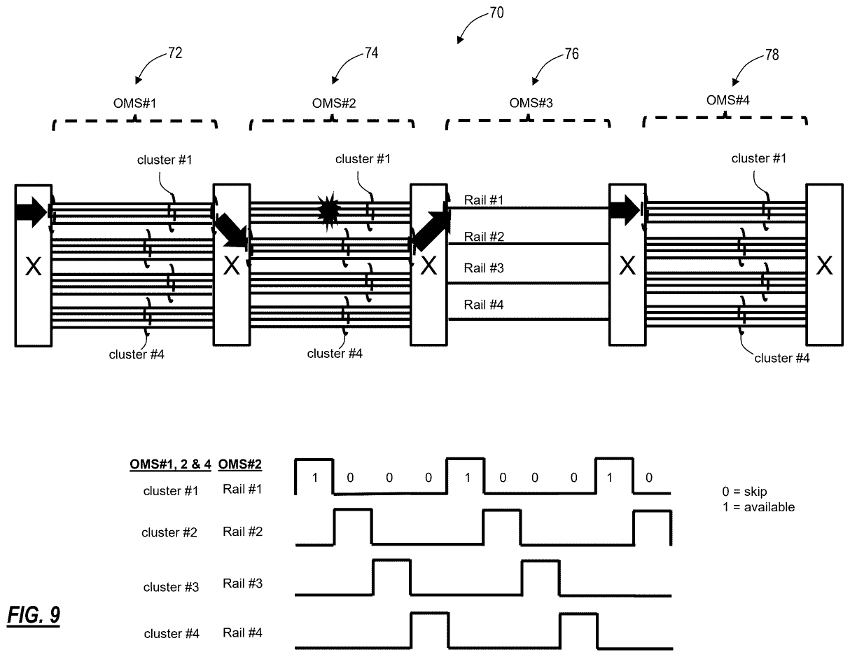

FIG. 9 illustrates a multi-rail optical network 70 including four OMSs 72, 74, 76, 78, demonstrating the benefits of performing local switching in the event of a rail (or cluster) failure. In this example, if the first cluster in OMS 74 experiences a fault, the affected traffic can be rerouted by switching at the local “head” and “tail” nodes of that cluster. Unlike traditional end-to-end protection methods, this localized approach does not require wavelength retuning or extensive messaging protocols across the entire network. Consequently, service restoration can be initiated more quickly and with less complexity-only the nodes immediately adjacent to the failing cluster need to be reconfigured, while the rest of the network continues operating normally. This method thus isolates the fault to a limited portion of the system and preserves bandwidth assignments, ensuring high resiliency without imposing significant operational overhead on other network segments.

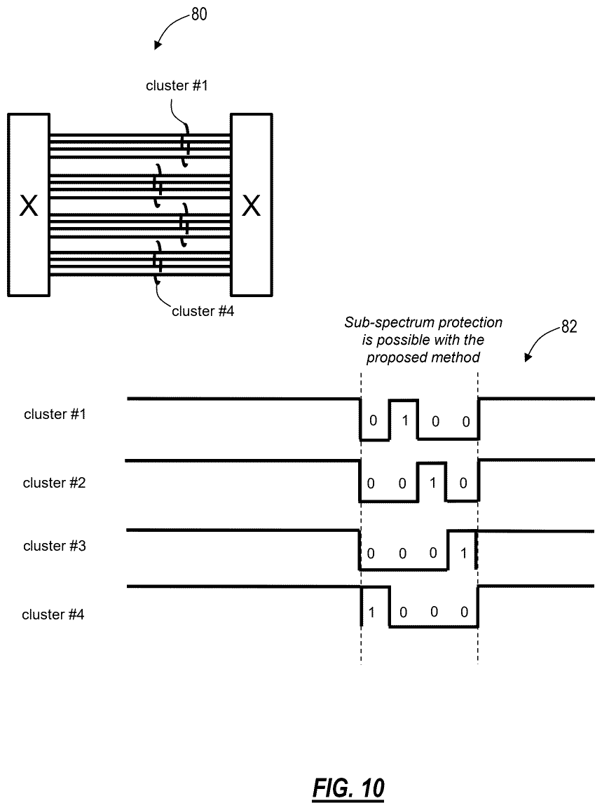

FIG. 10 illustrates an OMS 80 configured to enable sub-spectrum protection, meaning only a defined subset of the overall spectral band is reserved for high-priority traffic with interleaving-based protection. This approach contrasts with conventional broadband (trunk) protection, where the entire wavelength band on a failed rail is forcibly switched to another rail. Instead, operators can devote selected portions of the total spectrum, illustrated in diagram 82 as a sub-band, to protection and interleaving, allowing them to increase overall capacity on the rails or clusters while ensuring that only the mission-critical (high-priority) channels remain fully protected. In practical terms, if the total usable spectrum is approximately 5 THz, an operator might dedicate 2 THz to the interleaving-based protection scheme across four rails or clusters, leaving the remaining 3 THz (or 60% of the spectrum) freely assignable. This means that each rail still carries around 4 THz of capacity, representing roughly 80% of the total, while retaining the ability to switch the protected 2 THz sub-band among rails in the event of a failure. By adjusting how much of the spectrum is set aside for protection, along with the number of clusters, network engineers can finely tune the trade-off between redundancy and overall throughput, leading to a more flexible and efficient use of available bandwidth than is possible with full-band trunk protection.

The following formulas describe the capacity per rail

$$\begin{matrix}{capacitybandwidth}_{rail} = ( full traffic bandwidth - protection bandwidth ) \\ + \frac{protection bandwidth}{number of clusters}\end{matrix}$$

$${capacitybandwidth}_{rail} = full traffic bandwidth - protection bandwidth * ( 1 - \frac{1}{number of clusters} )$$

This approach manages wavelengths across multiple rails, aiming to improve traffic protection and restoration at a sub-spectrum (wavelength) level rather than relying on traditional “all-or-nothing” trunk or fiber-based schemes. In particular, multi-rail configurations with the total capacity is divided among several parallel rails. potentially grouped into clusters, are interleaved to increase resiliency and flexibility. Because each cluster of rails can be treated as a shared-risk group, traffic can be switched to a different rail or cluster if a physical event (e.g., a fiber cut) affects one of the rails.

An aspect is the concept of local, OMS-level switching, which avoids the need for end-to-end restorations (e.g., control plane) and thereby simplifies operations. Compared to trunk (fiber) protection, which duplicates or switches an entire fiber's worth of traffic, wavelength-granular protection allows only selected high-priority wavelengths to be assigned redundancy, other wavelengths can remain unprotected or use a lower-priority backup. This “partial protection” strategy ensures that the rest of the spectrum is still fully utilized by normal traffic. Such sub-spectrum protection thus provides a clear operational advantage in large, high-capacity networks, letting operators assign different resiliency tiers to different wavelengths without allocating an entire spare rail or fiber for protection.

There are tradeoffs in operational complexity and capacity planning. By segmenting the total spectrum (e.g., assigning 25% to each rail in a four-rail scenario), traffic from a failed rail can be readily moved onto available capacity in surviving rails. This approach is more efficient than standard 1:1 protection, especially in dense mesh networks where hardware reconfiguration or extensive signaling can become cumbersome. Ultimately, software-programmable, wavelength-based protection sub-spectrum protection offers a compelling use case. It enables operators to choose precisely which wavelengths merit redundancy, conserves overall bandwidth, and significantly reduces operational overhead by confining fault handling to local segments rather than triggering network-wide reassignments.

A motivation for using a wavelength-based approach, rather than a solution such as optical protection switching (OPS) that swaps entire rails to a different path, is the need to preserve capacity while still offering redundancy. In large multi-rail networks, operators want to protect against rail failures without dedicating an entire rail to backup. Although capacity is the primary goal, the failure rate also increases with more rails in service. Global content providers (GCNs) often attempt to push protection responsibilities up to Layer 3, thereby maximizing capacity at Layer 0. However, if Layer 0 rail redundancy is desired, some degree of capacity sacrifice is inevitable. This approach offers a middle ground: by assigning only a portion of the spectrum (sub-spectrum) as protected, operators avoid switching every channel on a failing rail to a backup rail. Instead, the protected subset of wavelengths moves, leaving other best-effort channels untouched. This sub-spectrum approach allows flexible tuning between maximum capacity per rail and high-priority protection requirements.

Regarding inter-ROADM messaging, the design manages multiple rails (e.g., quad-rails) within a single node or site, thereby requiring messaging primarily among the shelves of that local site. Some signaling may traverse from one site to the next (neighboring ROADM nodes), but if all parallel rails are collocated, intra-site coordination could handle most of the switching. Disaggregated shelf architectures would necessitate a software defined networking (SDN)-based control plane to coordinate switching at the demux and mux across multiple shelves.

Under this scheme, any rail in a cluster can protect any other rail in the same group. The choice of which rail to use as the backup can be determined by priority rules set in the routing or spectrum assignment protocol, but it can also be as simple as selecting the next available rail. The operation, administration, maintenance, and provisioning (OAM&P) procedures would be similar in concept to existing protection mechanisms (1+1, 1:1, 1:N), but adapted for sub-spectrum assignments. If shelves are disaggregated, an SDN-based controller could oversee the channel-level switching, ensuring that each transponder and multiplexer receives the appropriate commands.

When traffic fails over to a protection path, bundling rules may be less of a concern because this scheme focuses on spectral-slot assignments rather than rigid channel groupings. The interleaving spectrum design effectively enables fast restoration since each slot can be treated independently, without requiring large Nx groupings to switch at once. For instance, where Nx bundles (e.g., 12-channel bundles) are normally used, this interleaved sub-spectrum approach could switch each slot on demand, thus potentially speeding up restoration times when a single rail goes down.

An advantage lies in applying protection to only a “slice” of the total spectrum rather than the entire band. This sub-spectrum approach is highly programmable: operators can decide which wavelengths or channels receive protection and which do not, thus optimizing capacity or resiliency as needed. Because the scheme does not require frequency re-tuning, it simplifies both operations and planning, while still supporting the higher-level objective of managing capacity and survivability in multi-rail networks. Consequently, it enables an efficient, scalable, and flexible solution in software for allocating spectrum and ensuring high-priority traffic remains protected without needlessly sacrificing the entire rail's capacity.

While the primary purpose of multi-rail designs is indeed to increase capacity (not route diversity), it is quite common for large network operators—especially those building 12× or 16× fiber pairs in a single conduit—to run parallel rails. Some of these fiber pairs may already be in use or belong to different vendors, so the availability of “extra” fibers for each operator can vary. Importantly, these rails often share the same physical route, providing uniform latency rather than diverging geographically. In harsh deployment environments or managed optical fiber networks (MOFNs), however, some level of route diversity or additional resiliency may be desired, necessitating a balance between raw capacity and potential protection at Layer 0.

Although multi-rail systems are largely driven by capacity needs, operators frequently face practical constraints that force them to consider layer-0 (optical-level) protection. Some GCN providers currently use a scheme where half of the bandwidth is essentially “kept in reserve,” ensuring quick failover if part of the optical infrastructure goes down. This is not always feasible or cost-effective, especially if many parallel rails are involved and full redundancy on each rail would severely limit available capacity. A sub-spectrum protection approach can alleviate these concerns: rather than dedicating an entire rail to protection, a portion of the spectral band is earmarked for high-priority traffic. The rest remains unprotected (or protected at a lower level), preserving most of the rail's capacity.

Planning engineers sometimes worry about having to design for the “lowest common denominator” of optical signal-to-noise ratio (OSNR/ESNR) when switching between any possible rail. In a strictly parallel, same-route scenario, however, the rails generally have comparable impairments and latencies, minimizing discrepancies in margin. Thus, the typical mindset of “lowest ESNR path” is less pertinent if each rail is physically very similar. Moreover, new multi-rail designs address high-capacity needs-if route diversity is introduced, it is often for resiliency rather than solely for OSNR optimization.

A concern is that configuring four or more active rails, each carrying different regions of spectrum simultaneously, may drive up system costs compared to a simple wholesale fiber path switch. However, such a configuration is not necessarily static: operators can choose to cluster rails (e.g., grouping 8 rails at 50% capacity each), or they can run some rails at full capacity and others partially for protection. Sub-spectrum protection permits a flexible middle ground—if protection is crucial, some fraction of the spectrum can be interleaved or reserved; if more capacity is needed, operators can relax or disable that reservation. This adjustability is key in large 16× rail networks where operators want more nuanced gradations between 100% capacity and no protection.

The proposed approach's focus is on how to logically segment and allocate spectrum among multiple rails, clusters, and protection levels. Whether the hardware is colorless, directionless, contentionless, or fixed-filtered, the underlying method for carving out sub-bands of protected versus unprotected wavelengths remains applicable. Thus, while portions of the concept may echo established restoration ideas, the specific emphasis on multi-rail sub-spectrum protection, along with flexible clustering and capacity/resiliency trade-offs, addresses a distinctly modern scaling challenge that arises when deploying a dozen or more parallel rails in a single conduit.

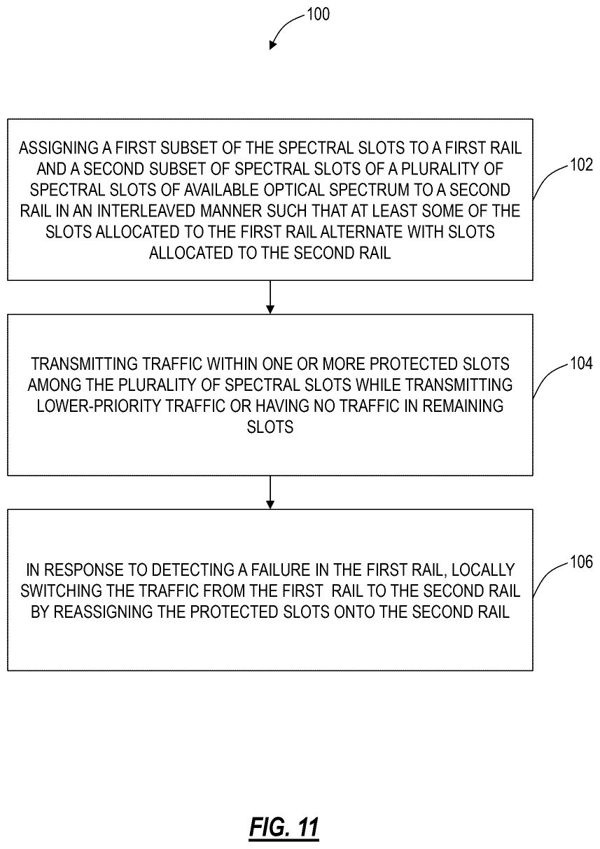

FIG. 11 illustrates a flowchart of a process 100 of managing optical wavelengths in a multi-rail optical network 10. As described herein, the network 10 includes at least two parallel rails each configured to carry optical signals between a first node and a second node. The process 100 contemplated implementation in the multi-rail optical network 10, via any of the ROADMs and in any of the OMSs.

The process 100 includes assigning a first subset of spectral slots of a plurality of spectral slots of available optical spectrum to a first rail and a second subset of the spectral slots to a second rail in an interleaved manner such that at least some of the slots allocated to the first rail alternate with slots allocated to the second rail (step 102); transmitting within one or more protected slots among the plurality of spectral slots while transmitting lower-priority traffic or having no traffic in remaining slots (step 104); and, in response to detecting a failure in the first rail, locally switching the traffic from the first rail to the second rail by reassigning the protected slots onto the second rail without retuning (step 106).

The plurality of spectral slot can include only a subset of the available spectrum for the traffic which is high-priority without requiring an entire rail's bandwidth to be dedicated to protection, thereby providing sub-spectrum protection for the high-priority traffic. The process 100 can include clustering two or more rails such that each cluster shares at least one overlapping subset of spectral slots, and upon detecting the failure of one rail in the cluster, switching affected traffic to at least one other rail in a different cluster. For example, the first rail and the second rail are in different clusters. The clustering is designed such that each cluster includes M rails and each optical multiplex section (OMS) includes N total rails, and wherein the clustering allows for up to N/M simultaneous rail failures without loss of the traffic.

The interleaved manner can include defining uniformly spaced spectral slots of a predetermined width, and allocating odd-numbered slots to the first rail while allocating even-numbered slots to the second rail. The interleaved manner can include assigning variable-width spectral slots to accommodate different signal types. The process 100 can include maintaining consistency of the interleaved manner of spectral slots across multiple optical multiplex sections (OMSs) along an optical path, such that traffic channels is switchable from one OMS to another.

The process 100 can include dynamically adjusting a proportion of spectrum reserved for protected slots in response to changing network conditions or traffic demands; and reallocating at least one previously unprotected slot to carry additional high-priority traffic when a new protection requirement arises, providing flexible sub-spectrum protection using software-controlled reconfiguration. The process 100 can include monitoring optical signal metrics on each rail and selecting an operational rail that meets a minimum threshold for the optical signal metrics for carrying high-priority traffic upon detection of a failure.

The locally switching the traffic can include detecting a rail failure at a local reconfigurable optical add-drop multiplexer (ROADM) node adjacent to the first rail; and signaling only between the local ROADM and a neighboring ROADM to coordinate reallocation of the protected slots, avoiding end-to-end restoration protocols that span the network. The process 100 can include employing a software defined networking (SDN) controller in a disaggregated shelf architecture to coordinate channel-level switching among different shelves, wherein each shelf accommodates one or more rails. The failure can include at least one of a physical fiber cut in the rail, an amplifier failure along the rail, or a wavelength-selective switch (WSS) malfunction in the rail, such that the local switching reassigns only the protected spectral slots. The process 100 can include storing in a network planning tool data structures representing the interleaved spectrum allocation, clustering rules, and protection thresholds.

The first subset and the second subset can be assigned as a function of network demands and redundancy requirements, and the subsets can be assigned in multiple options between increased capacity and increased protection. For example, the multiple options can include different numbers of protected slots where there are less protected slots for more capacity.

In another embodiment, a reconfigurable optical add-drop multiplexer (ROADM) node for a multi-rail optical network includes an optical switching subsystem that includes one or more wavelength-selective switches (WSSs); and a controller operably coupled to the optical switching subsystem, wherein the controller is configured to assign a first subset of spectral slots of a plurality of spectral slots of available optical spectrum to a first rail and a second subset of the spectral slots to a second rail in an interleaved manner such that at least some of the slots allocated to the first rail alternate with slots allocated to the second rail, cause transmission of traffic within one or more protected slots among the plurality of spectral slots while transmitting lower-priority traffic or leaving unoccupied remaining slots, and upon detection a failure in the first rail, cause a local switch of the traffic from the first rail to the second rail by reallocating only the protected slots.

As used herein, “available optical spectrum” refers to the total range of optical frequencies or wavelengths recognized by the system for data transmission-such as the full C-band or any other defined band-within which one or more channels can be provisioned. This encompasses all the usable wavelengths that can be allocated for carrying traffic, whether high-priority, best-effort, or otherwise. Further, “interleaved manner” and “interleaving” describe allocating different, non-overlapping portions of the available optical spectrum among multiple rails (or among clusters of rails) so that each rail or cluster has its own distinct spectrum segment. While examples may depict slot-by-slot or round-robin assignments, interleaving does not require any specific periodicity or evenly spaced slots. Rather, any arrangement that cleanly separates the overall spectrum into mutually exclusive segments counts as interleaving, enabling high-priority traffic to be switched locally among rails when a failure occurs.

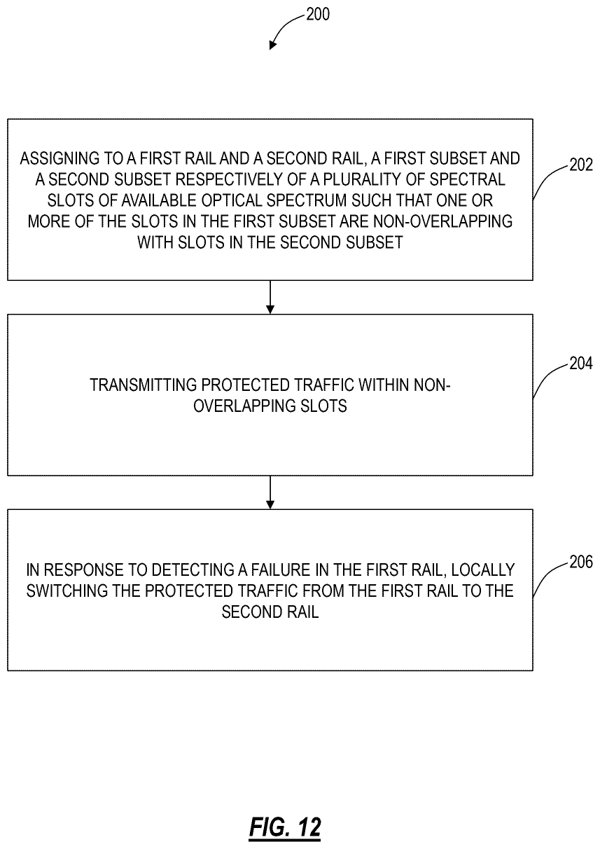

FIG. 12 illustrates a flowchart of another process 200 of managing optical wavelengths in a multi-rail optical network 10. As described herein, the network 10 includes at least two parallel rails each configured to carry optical signals between a first node and a second node. The process 200 contemplated implementation in the multi-rail optical network 10, via any of the ROADMs and in any of the OMSs.

The process 200 includes assigning to a first rail and a second rail, a first subset and a second subset respectively of a plurality of spectral slots of available optical spectrum such that one or more of the slots in the first subset are non-overlapping with slots in the second subset (step 202); transmitting protected traffic within non-overlapping slots (step 204); and, in response to detecting a failure in the first rail, locally switching the protected traffic from the first rail to the second rail (step 206). The locally switching can provide sub-spectrum protection for the protected traffic without requiring an entire rail's bandwidth to be dedicated to protection or retuning of the protected traffic.

The process 200 can further include clustering two or more rails such that each rail in a cluster shares at least one overlapping spectral slot for protected traffic, and, upon detecting the failure of one first rail in a first cluster, switching affected protected traffic to the second rail in a different cluster. The clustering is designed such that each cluster includes M rails and each optical multiplex section (OMS) includes N total rails, and wherein the clustering allows for up to N/M simultaneous rail failures without loss of the traffic. The plurality of spectral slots can be variable-width spectral slots to accommodate different signal types. The plurality of spectral slots can be variable-width spectral slots to accommodate different signal types.

The process 200 can further include maintaining consistency of the spectral slots across multiple optical multiplex sections (OMSs) along an optical path, such that traffic channels is switchable from one OMS to another. The process 200 can further include dynamically adjusting a proportion of spectrum reserved for protected slots in response to changing network conditions or traffic demands; and reallocating at least one previously unprotected slot to carry additional protected traffic when a new protection requirement arises, providing flexible sub-spectrum protection using software-controlled reconfiguration. The process 200 can further include monitoring optical signal metrics on each rail and selecting an operational rail that meets a minimum threshold for the optical signal metrics for carrying protected traffic upon detection of a failure.

The locally switching the traffic can include detecting a rail failure at a local reconfigurable optical add-drop multiplexer (ROADM) node adjacent to the first rail; and signaling only between the local ROADM and a neighboring ROADM to coordinate reallocation of the protected slots, avoiding end-to-end restoration protocols that span the network. The process 200 can further include employing a software defined networking (SDN) controller in a disaggregated shelf architecture to coordinate channel-level switching among different shelves, wherein each shelf accommodates one or more rails.

The failure includes at least one of a physical fiber cut in the rail, an amplifier failure along the rail, or a wavelength-selective switch (WSS) malfunction in the rail. The first subset and the second subset can be assigned as a function of network demands and redundancy requirements, and wherein the subsets are assigned in multiple options between increased capacity and increased protection.

In a further embodiment, a reconfigurable optical add-drop multiplexer (ROADM) includes an optical switching subsystem that includes one or more wavelength-selective switches (WSSs); and a controller operably coupled to the optical switching subsystem, wherein the controller is configured to assign to a first rail and a second rail, a first subset and a second subset respectively of a plurality of spectral slots of available optical spectrum such that one or more of the slots in the first subset are non-overlapping with slots in the second subset, and wherein protected traffic is transmitted within non-overlapping slots, and, in response to detecting a failure in the first rail, cause a local switch of the protected traffic from the first rail to the second rail.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method of managing optical wavelengths in a multi-rail optical network, the network includes at least two parallel rails each configured to carry optical signals between a first node and a second node, the method comprising:
assigning to a first rail and a second rail, a first subset and a second subset respectively of a plurality of spectral slots of available optical spectrum such that one or more of the slots in the first subset are non-overlapping with slots in the second subset;
transmitting protected traffic within non-overlapping slots; and
in response to detecting a failure in the first rail, locally switching the protected traffic from the first rail to the second rail.

2. The method of claim 1, wherein the locally switching provides sub-spectrum protection for the protected traffic without requiring an entire rail's bandwidth to be dedicated to protection or retuning of the protected traffic.

3. The method of claim 1, further comprising
clustering two or more rails such that each rail in a cluster shares at least one overlapping spectral slot for protected traffic, and
upon detecting the failure of one first rail in a first cluster, switching affected protected traffic to the second rail in a different cluster.

4. The method of claim 3, wherein the clustering is designed such that each cluster includes M rails and each optical multiplex section (OMS) includes N total rails, and wherein the clustering allows for up to N/M simultaneous rail failures without loss of the traffic.

5. The method of claim 1, wherein the plurality of spectral slots are variable-width spectral slots to accommodate different signal types.

6. The method of claim 1, wherein the plurality of spectral slots are variable-width spectral slots to accommodate different signal types.

7. The method of claim 1, further comprising maintaining consistency of the spectral slots across multiple optical multiplex sections (OMSs) along an optical path, such that traffic channels is switchable from one OMS to another.

8. The method of claim 1, further comprising
dynamically adjusting a proportion of spectrum reserved for protected slots in response to changing network conditions or traffic demands; and
reallocating at least one previously unprotected slot to carry additional protected traffic when a new protection requirement arises, providing flexible sub-spectrum protection using software-controlled reconfiguration.

9. The method of claim 1, further comprising
monitoring optical signal metrics on each rail and selecting an operational rail that meets a minimum threshold for the optical signal metrics for carrying protected traffic upon detection of a failure.

10. The method of claim 1, wherein the locally switching the traffic includes
detecting a rail failure at a local reconfigurable optical add-drop multiplexer (ROADM) node adjacent to the first rail; and
signaling only between the local ROADM and a neighboring ROADM to coordinate reallocation of the protected slots, avoiding end-to-end restoration protocols that span the network.

11. The method of claim 1, further comprising
employing a software defined networking (SDN) controller in a disaggregated shelf architecture to coordinate channel-level switching among different shelves, wherein each shelf accommodates one or more rails.

12. The method of claim 1, wherein the failure includes at least one of
a physical fiber cut in the rail,
an amplifier failure along the rail, or
a wavelength-selective switch (WSS) malfunction in the rail.

13. The method of claim 1, wherein the first subset and the second subset are assigned as a function of network demands and redundancy requirements, and wherein the subsets are assigned in multiple options between increased capacity and increased protection.

14. A reconfigurable optical add-drop multiplexer (ROADM) node for a multi-rail optical network, the multi-rail optical network comprising at least two parallel rails each configured to carry optical signals between a first node and a second node, the ROADM node comprising:
an optical switching subsystem that includes one or more wavelength-selective switches (WSSs); and
a controller operably coupled to the optical switching subsystem,
wherein the controller is configured to
assign to a first rail and a second rail, a first subset and a second subset respectively of a plurality of spectral slots of available optical spectrum such that one or more of the slots in the first subset are non-overlapping with slots in the second subset, and wherein protected traffic is transmitted within non-overlapping slots, and
in response to detecting a failure in the first rail, cause a local switch of the protected traffic from the first rail to the second rail.

15. The ROADM of claim 14, wherein the local switch provides sub-spectrum protection for the protected traffic without requiring an entire rail's bandwidth to be dedicated to protection or retuning of the protected traffic.

16. The ROADM of claim 14, wherein two or more rails are clustered such that each rail in a cluster shares at least one overlapping spectral slot for protected traffic, and the controller is further configured to
upon detecting the failure of one first rail in a first cluster, cause the local switch of affected protected traffic to the second rail in a different cluster.

17. The ROADM of claim 14, wherein the plurality of spectral slots are variable-width spectral slots to accommodate different signal types.

18. The ROADM of claim 14, wherein the plurality of spectral slots are variable-width spectral slots to accommodate different signal types.

19. The ROADM of claim 14, wherein the controller is further configured to
dynamically adjust a proportion of spectrum reserved for protected slots in response to changing network conditions or traffic demands, and
reallocate at least one previously unprotected slot to carry additional protected traffic when a new protection requirement arises, providing flexible sub-spectrum protection using software-controlled reconfiguration.

20. The ROADM of claim 14, wherein the controller is further configured to
monitoring optical signal metrics on each rail and selecting an operational rail that meets a minimum threshold for the optical signal metrics for carrying protected traffic upon detection of a failure.
